(19) United States
(12) Patent Application Publication
(10) Pub. No.: US 2015/0022650 A1
(43) Pub. Date: Jan. 22, 2015

(54) NETWORK CAMERA HAVING IRIS DETECTION FUNCTION AND IRIS DETECTION METHOD

(71) Applicant: VIVOTEK INC., New Taipei (TW)

(72) Inventor: Yen-Chieh HUANG, New Taipei (TW)

(21) Appl. No.: 14/333,815

(22) Filed: Jul. 17, 2014

(30) Foreign Application Priority Data
Jul. 17, 2013 (TW) 102125580

(51) Int. Cl. H04N 5/232; G06K 9/00

(52) U.S. Cl. CPC H04N 5/23219; G06K 9/00604
USPC 348/78

(57) ABSTRACT

A network camera with an iris detection function and an iris detection method are provided. The network camera may include a machine body connected to a first iris or a second iris. The machine body may include a detection unit, a test signal generation unit, and a processing unit. The detection unit may include a test signal output terminal and a test signal receiving terminal. The test signal generation unit electrically connected to the detection unit may generate a first test signal and output the first test signal to the first iris or the second iris through the test signal output terminal. The test signal receiving terminal may receive a second test signal from the first iris or the second iris. The processor unit connected to the detection unit may generate a warning signal according to the second test signal.

### CROSS-REFERENCE TO RELATED APPLICATIONS

This non-provisional application claims priority under 35 U.S.C. §119(a) on Patent Application No(s). 102125580 filed in Taiwan, R.O.C. on Jul. 17, 2013, the entire contents of which are hereby incorporated by reference.

### TECHNICAL FIELD

The disclosure relates to a network camera with an iris detection function and an iris detection method, more particularly to a network camera with an iris detection function and an iris detection method, which is capable of detecting the categories of aperture stop (e.g. an iris diaphragm referred to simply as an iris) for the camera lens of the network camera and protecting the irises from being damaged.

### BACKGROUND

Over the years, with the enhancement of electronic technology, global broadband network is built more completely as well as the demand for security surveillance industry, applied in, for example, home care, anti-theft and safety protection fields, becomes more and more. As security surveillance products, no matter conventional closed circuit televisions (CCTV) or network cameras, utilize their lens to perform video capture. Since cameras nowadays have more various functions than before, it helps the vigorous development of lens of the network camera.

Camera lenses for different type network cameras having different type of irises usually cooperate with different motor drivers such that different type of irises in the camera lenses can be operated. However, once one camera lens is replaced by another one suddenly, since the work voltage to the motor driver may become too high and continue being applied to the motor driver, the iris may be damaged. Moreover, if the network camera does not have any design to detect whether the camera lens is replaced, no warning will be provided to protect the iris from be damaged.

### SUMMARY

According to one or more embodiments, the disclosure provides a network camera with an iris detection function. In one embodiment, the network camera may include a machine body. The machine body may connect to a first iris or a second iris and include a detection unit, a test signal generation unit, and a processing unit. The detection unit may include a test signal output terminal and a test signal receiving terminal. The test signal generation unit may electrically connect to the detection unit. The test signal generation unit may generate a first test signal and output it to the first iris or the second iris via the test signal output terminal. The test signal receiving terminal may receive a second test signal from the first iris or the second iris. The processing unit may electrically connect to the test signal generation unit and the detection unit. The processing unit may generate a warning signal according to the first test signal and the second test signal.

According to one or more embodiments, the disclosure provides an iris detection method for detecting connection between a network camera and a first iris or connection between the network camera and a second iris. In one embodiment, the iris detection method may include steps of: outputting a first test signal to the first iris or the second iris; receiving a second test signal from the first iris or the second iris; generating a voltage signal according to the second test signal, wherein the voltage signal commands the network camera to connect with the first iris or the second iris; and generating a warning signal according to the voltage signal.

### BRIEF DESCRIPTION OF THE DRAWINGS

The present disclosure will become more fully understood from the detailed description given herein below for illustration only and thus does not limit the present disclosure, wherein:

FIG. 1 is a schematic diagram of a first embodiment of a network camera with an iris detection function;

FIG. 2 is a schematic diagram of a second embodiment of a network camera with an iris detection function;

FIG. 3 is a schematic diagram of a third embodiment of a network camera with an iris detection function;

FIG. 4 is a schematic timing diagram of an embodiment of a first test signal;

FIG. 5 is a schematic timing diagram of another embodiment of a first test signal;

FIG. 6 is a schematic diagram of a fourth embodiment of a network camera with an iris detection function;

FIG. 7 is a schematic diagram of a fifth embodiment of a network camera with an iris detection function;

FIG. 8 is a schematic diagram of a sixth embodiment of a network camera with an iris detection function; and

FIG. 9 is a flow chart of an embodiment of an iris detection method.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the following one or more embodiments, the same or similar elements may be marked by the same labels.

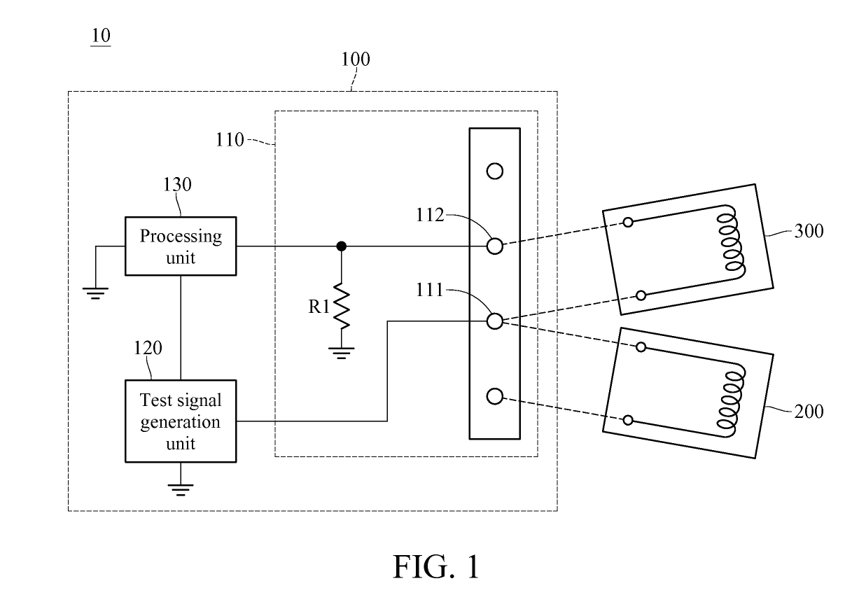

FIG. 1 is a schematic diagram of a first embodiment of a network camera with an iris detection function. A network camera 10 may include a machine body 100. The machine body 100 may connect to a first iris 200 or a second iris 300. In one embodiment, the first iris 200 and the second iris 300 may comprise a precise iris (P-IRIS) or a DC iris (DC-IRIS). The first iris 200 and the second iris 300 shown in FIG. 1 are schematic diagrams. Generally, an iris electrically connects to a machine body via four pins. Nevertheless, this embodiment only shows two pins in order to simplify the relative description. One pin may electrically connect to the test signal output terminal 111, and the other pin may electrically connect to the test signal receiving terminal 112 or other part of the detection unit 110 in response to the category of the iris. After the pins electrically connect to the detection unit 110, the pins and the machine body 100 may cooperate to form an electric loop in the disclosure. In this embodiment, the first iris 200 may be a DC iris, and the second iris 300 may be a precise iris. The machine body 100 may include a detection unit 110, a test signal generation unit 120, and a processing unit 130.

The detection unit 110 may include a test signal output terminal 111 and a test signal receiving terminal 112. The test signal generation unit 120 may electrically connect to the detection unit 110 and may generate a first test signal and output the first test signal to the first iris 200 or the second iris 300 via the test signal output terminal 111. The test signal receiving terminal 112 may receive a second test signal from the first iris 200 or the second iris 300 that responds to the first test signal. In this embodiment, the first test signal may include a test voltage or a test current.

The processing unit 130 may electrically connect to the test signal generation unit 120 and the detection unit 110. The processing unit 130 may generate a warning signal according to the first test signal and the second test signal. In this or some embodiments, the warning signal may command the network camera 10 to restart itself, perform the switch of operation modes for irises, or play alarm sounds. In this or some embodiments, the processing unit 130 may be embodied by a system on a chip (SOC) or other similar electric components.

Take an example. When the machine body 100 connects to the first iris 200, the connection between the test signal output terminal 111 and the test signal receiving terminal 112 may be disabled. Herein, when the test signal generation unit 120 generates and outputs the first test signal, the test signal receiving terminal 112 may not receive the second test signal. Therefore, the detection unit 110 may generate, for example, a low logical level voltage signal. Alternately, when the machine body 100 connects to the second iris 300, the connection between the test signal output terminal 111 and the test signal receiving terminal 112 may be enabled. Herein, when the test signal generation unit 120 generates the first test signal and outputs it via the test signal output terminal 111, the test signal receiving terminal 112 may receive the second test signal. Therefore, the detection unit 110 may generate, for example, a high logical level voltage signal.

Then, the processing unit 130 may, according to the occurrence of the first test signal, determine whether to output the warning signal when the detection unit 110 generates the high logical level voltage signal or the low logical level voltage signal. For example, the processing unit 130 may start the determination procedure to decide whether to output the warning signal when the first test signal is generated, and then output the warning signal when the detection unit 110 generates the high logical level voltage signal. Alternately, the processing unit 130 may start the determination procedure to decide whether to output the warning signal when the first test signal is generated, and then output the warning signal when the detection unit 110 generates the low logical level voltage signal. Therefore, which signal to command the processing unit 130 to output the warning signal may be defined by users, but the disclosure will not be limited thereto.

In addition, the detection unit 110 may further include a first resistor R1. One of two ends of the first resistor R1 may couple to the test signal receiving terminal 112, the other one of the two ends of the first resistor R1 may be grounded. The first resistor R1 and the processing unit 130 may connected in parallel. The high logical level voltage signal or the low logical level voltage signal generated by the detection unit 110 may be the voltage difference between the two ends of the first resistor R1. The processing unit 130 may generate the warning signal according to the voltage difference and the occurrence of the first test signal.

In some embodiments, the first resistor R1 may removable. In other words, the processing unit 130 may directly generate the warning signal according to the high logical level voltage signal or the low logical level voltage signal generated by the detection unit 110. This may achieve the same effect as the previous one or more embodiments.

In an exemplary embodiment, assume the network camera 10 is preset to use the first iris 200. When the machine body 100 connects to the second iris 300, the connection between the test signal output terminal 111 and the test signal receiving terminal 112 may be enabled. Herein, when the test signal generation unit 120 generates a first test signal and outputs the first test signal via the test signal output terminal 111, the test signal receiving terminal 112 may receive the second test signal such that the detection unit 110 may generate a high logical level voltage signal. Accordingly, the processing unit 130 in the network camera 10 may determine that the machine body 100 connects to the second iris 300, and then send out a warning signal. For instance, this warning signal may command the network camera 10 to change the operation mode such that the network camera 10 may use the second iris 300 instead of the first iris 200.

Further, according to the voltage signal of the detection unit 110 and the occurrence of the first test signal, the processing unit 130 may continue determining whether the iris cooperating with the machine body 100 is replaced or not. The first test signal may change in respond to the switch of the operation modes. For instance, when the operation mode is changed to use the second iris 300 that is a precise iris, the first test signal may become a periodic voltage signal.

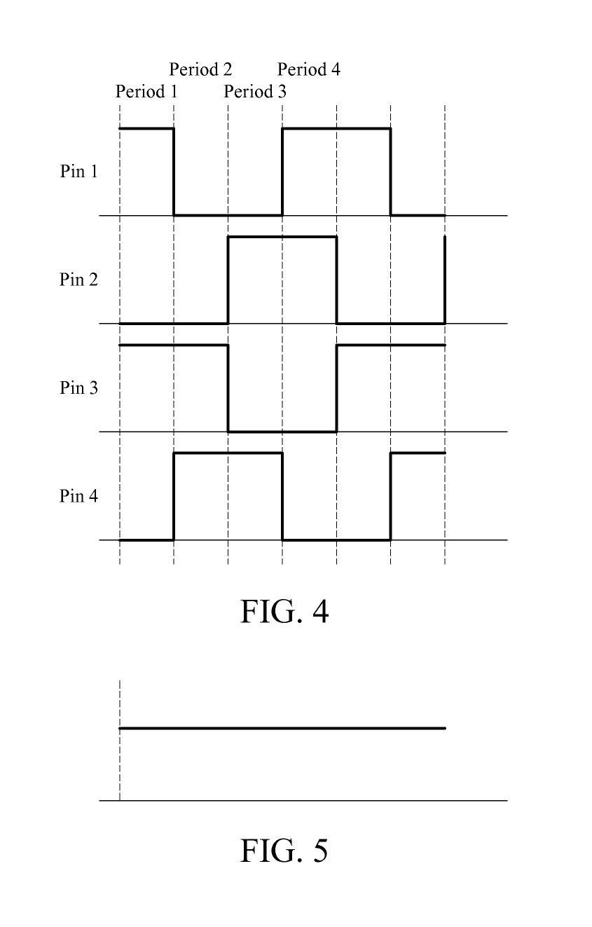

The control method for the precise iris may be shown in Table 1. Table 1 illustrates a corresponding relationship in the control method for the precise iris. In Table 1, the pins 1 to 4 are four pins of the precise iris respectively. The pins 1 and 4 may be paired and shown by the labels “B” and “B−”, and the pins 2 and 3 may be paired and shown by the labels “A” and “A−”. The labels “A” and “B” may represent positive phases, and the labels “A−” and “B−” may represent negative phases. The label “H” may represent a driving signal at a high logical level, and the label “L” may represent a driving signal at a low logical level. The waveforms of the driving signals for the pins 1 to 4 of the precise iris may be shown in FIG. 4.

TABLE 1

| Pin | Phase | Period 1 | Period 2 | Period 3 | Period 4 |
|---|---|---|---|---|---|
| 1 | B | H | L | L | H |
| 2 | A | L | L | H | H |
| 3 | A− | H | H | L | L |
| 4 | B− | L | H | H | L |

Furthermore, the pins 1 to 4 of the precise iris may respectively receive driving signals illustrated in Table 1 and shown in FIG. 4. For example, if the driving signal is continuously sent from the period 1 to the period 4, the precise iris may operate from off to on. In contrast, if the driving signal is continuously sent from the period 4 to the period 1, the precise iris may operate from on to off. Since the first test signal is the driving signal to drive the precise iris, the first test signal may become a periodic voltage signal illustrated in Table 1 in the operation mode to use the precise iris. In other words, the pin 2 of the precise iris may function as the test signal receiving terminal 112, and the driving signal to the pin 2 may be the periodic signal of “L, L, H, H”.

When the machine body 100 connects to the first iris 200, the connection between the test signal output terminal 111 and the test signal receiving terminal 112 may be disabled. Herein, when the test signal generation unit 120 generates a first test signal and outputs it through the test signal output terminal 111, the test signal receiving terminal 112 may not receive a second test signal such that the detection unit 110 may generate a low logical level voltage signal. Therefore, the processing unit 130 in the network camera 10 may determine that the machine body 100 connects to the first iris 200, and maintain this preset operation mode to use the first iris 200. Also, the processing unit 130 may still continue determining whether the iris cooperating with the machine body 100 is replaced or not, according to the voltage signal and the occurrence of the first test signal. Since the first iris 200 is a DC iris, the first test signal may be a continuous voltage signal.

In this embodiment, the control method of the DC iris may be to continue outputting a driving voltage, as shown in FIG. 5, to keep the DC iris on. Without the driving voltage, the DC iris may be off. Moreover, the first test signal may function as the driving voltage to drive the DC iris such that, in the operation mode to use the DC iris, the first test signal may be a continuous voltage signal.

When the machine body 100 has not connected to the first iris 200 and the second iris 300 yet, the connection between the test signal output terminal 111 and the test signal receiving terminal 112 may be disabled. When the test signal generation unit 120 generates the first test signal and outputs it through the test signal output terminal 111, the test signal receiving terminal 112 may not receive the second test signal such that the detection unit 110 may generate the low logical level voltage signal. Therefore, the processing unit 130 in the network camera 10 may determine that the machine body 100 connects to the first iris 200, and maintain the preset operation mode to use the first iris 200. Further, the processing unit 130 may continue determining whether the machine body 100 connects to the iris, according to the voltage signal of the detection unit 110 and the occurrence of the first test signal.

Furthermore, assume the preset operation mode of the network camera 10 is to use the second iris 300. When the machine body 100 connects to the second iris 300, the connection between the test signal output terminal 111 and the test signal receiving terminal 112 may be enabled. Herein, when the test signal generation unit 120 generates the first test signal and outputs it through the test signal output terminal 111, the test signal receiving terminal 112 may receive the second test signal such that the detection unit 110 may generate the high logical level voltage signal. Therefore, the processing unit 130 in the network camera 10 may determine that the machine body 100 connects to the second iris 300, and maintain the preset operation mode to use the second iris 300. Further, the processing unit 130 may continue determining whether the iris cooperating with the machine body 100 is replaced or not, according to the voltage signal of the detection unit 110 and the occurrence of the first test signal.

When the machine body 100 connects to the first iris 200, the connection between the test signal output terminal 111 and the test signal receiving terminal 112 may be disabled. Herein, when the test signal generation unit 120 generates the first test signal and outputs it through the test signal output terminal 111, the test signal receiving terminal 112 may not receive the second test signal such that the detection unit 110 may generate the low logical level voltage signal. Therefore, the processing unit 130 in the network camera 10 may determine that the machine body 100 connects to the first iris 200, and then switch to the operation mode to use the first iris 200. Further, the processing unit 130 may continue determining whether the iris cooperating with the machine body 100 is replaced or not, according to the voltage signal of the detection unit 110 and the occurrence of the first test signal. The first test signal may change in respond to the switch of the operation modes. For instance, when the operation mode is changed to use the first iris 200 that is a DC iris, the first test signal may be a continuous voltage signal.

When the machine body 100 has connected to neither the first iris 200 nor the second iris 300 yet, the connection between the test signal output terminal 111 and the test signal receiving terminal 112 may be disabled. Herein, when the test signal generation unit 120 generates the first test signal and outputs it through the test signal output terminal 111, the test signal receiving terminal 112 may not receive the second test signal such that the detection unit 110 may generate the low logical level voltage signal. Therefore, the processing unit 130 in the network camera 10 may determine that the machine body 100 connects to the first iris 200, and then switch to the operation mode to use the first iris 200. Further, the processing unit 130 may continue determining whether the machine body 100 connects to the iris, according to the voltage signal of the detection unit 110 and the occurrence of the first test signal. The first test signal may change in respond to the switch of the operation modes. For instance, when the operation mode is changed to use the first iris 200 that is a DC iris, the first test signal may be a continuous voltage signal.

Accordingly, the disclosure is capable of protecting the irises from being damaged, by switching the operation mode when the network camera 10 detects that the machine body 100 connects to the first iris 200 or the second iris 300.

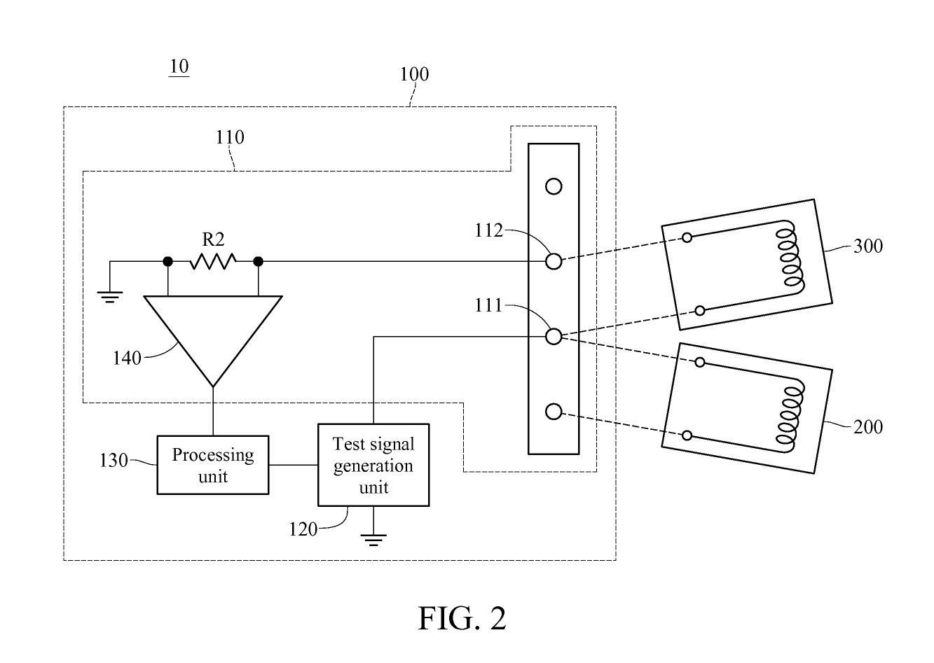

FIG. 2 is a schematic diagram of a second embodiment of a network camera with an iris detection function. In this embodiment, the detection unit 110 may further include a test signal amplifier 140 in view of the first embodiment. The test signal amplifier 140 may couple with the test signal receiving terminal 112 and the processing unit 130 and may receive and amplify the high logical level voltage signal or the low logical level voltage signal generated by the detection unit 110 and output the amplified high logical level voltage signal or the amplified low logical level voltage signal to the processing unit 130. Furthermore, the detection unit 110 may further include a second resistor R2. One of two ends of the second resistor R2 may couple with the first input end of the test signal amplifier 140 and the test signal receiving terminal 112, and the other one of the two ends of the second resistor R2 may couple with a second input end of the test signal amplifier 140. In this or some embodiments, the high logical level voltage signal or the low logical level voltage signal generated by the detection unit 110 may be the voltage difference between the two ends of the second resistor R2.

On the other hand, the arrangement and operation of other components in the network camera 10 can be referred to the first embodiment shown in FIG. 1, and may achieve the same effect as the first embodiment, and thus, they will not be repeated hereinafter.

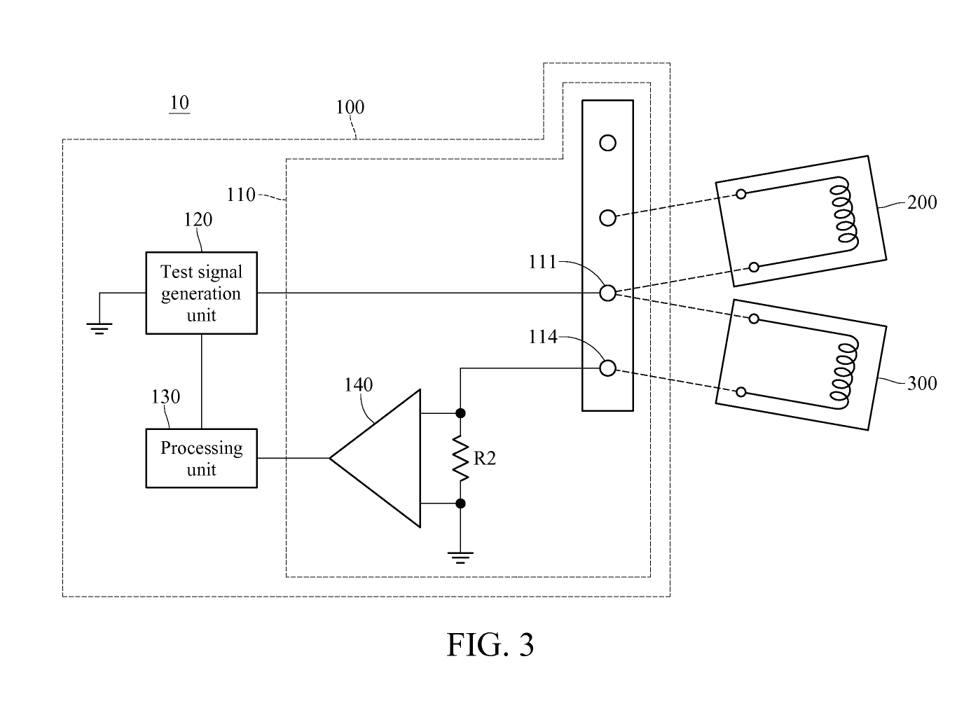

FIG. 3 is a schematic diagram of a third embodiment of a network camera with an iris detection function. In this embodiment, the first iris 200 may be embodied by a precise iris, and the second iris 300 may be embodied by a DC iris.

On the other hand, the detection unit 110 may further include a test signal amplifier 140. The test signal amplifier 140 may couple with the test signal receiving terminal 114 and the processing unit 130. The test signal amplifier 140 may receive and amplify generated by the detection unit 110 and output the amplified high logical level voltage signal or the amplified low logical level voltage signal to the processing unit 130. Furthermore, the detection unit 110 may further include a second resistor R2. One of two ends of the second resistor R2 may couple with a first input end of the test signal amplifier 140 and the test signal receiving terminal 114, and the other one of the two ends of the second resistor R2 may couple with a second input end of the test signal amplifier 140. The high logical level voltage signal or the low logical level voltage signal generated by the detection unit 110 may be the voltage difference between the two ends of the second resistor R2.

On the other hand, the arrangement and operation of other components in the network camera 10 can be referred to the first embodiment shown in FIG. 1, and may achieve the same effect as the first embodiment, and thus, they will not be repeated hereinafter.

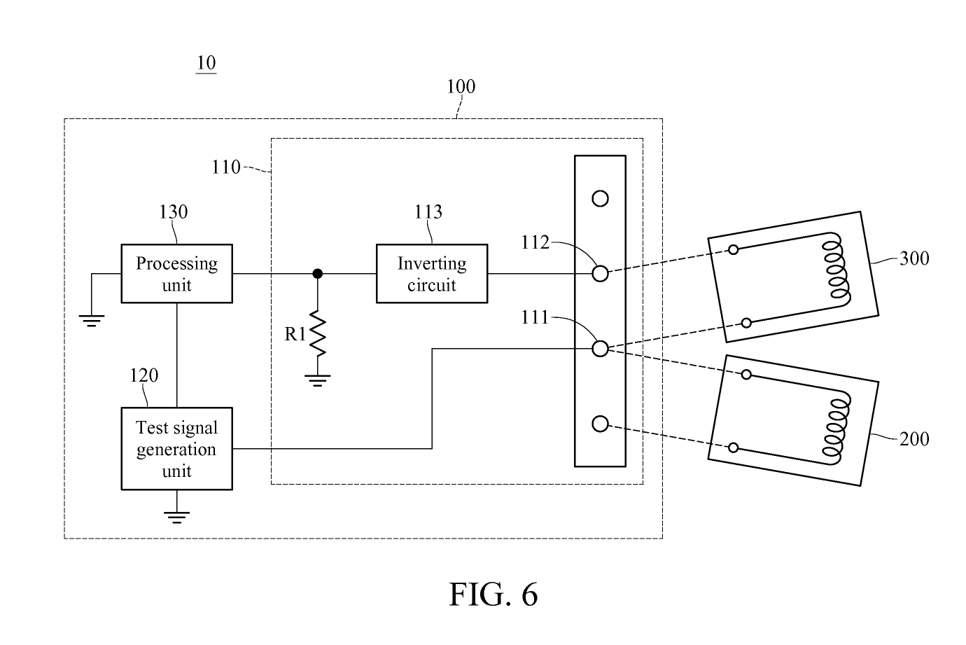

FIG. 6 is a schematic diagram of a fourth embodiment of a network camera with an iris detection function. In this embodiment, the network camera 10 may not only include the elements shown in FIG. 1 but also include an inverting circuit 113. The connection manner related to the inverting circuit 113 may be like the structure shown in FIG. 6. When the connection between the test signal output terminal 111 and the test signal receiving terminal 112 is disabled, the inverting circuit 113 may transform the low logical level voltage signal generated by the detection unit 110 into the high logical level voltage signal. In contrast, when the connection between the test signal output terminal 111 and the test signal receiving terminal 112 is enabled, the inverting circuit 113 may transform the high logical level voltage signal generated by the detection unit 110 into the low logical level voltage signal. Therefore, the processing unit 130 may generate the warning signal according to the output result of the inverting circuit 113.

On the other hand, the operation of the network camera 10 in this embodiment can be referred to the relative description to FIG. 1, and may achieve the same effect as the first embodiment.

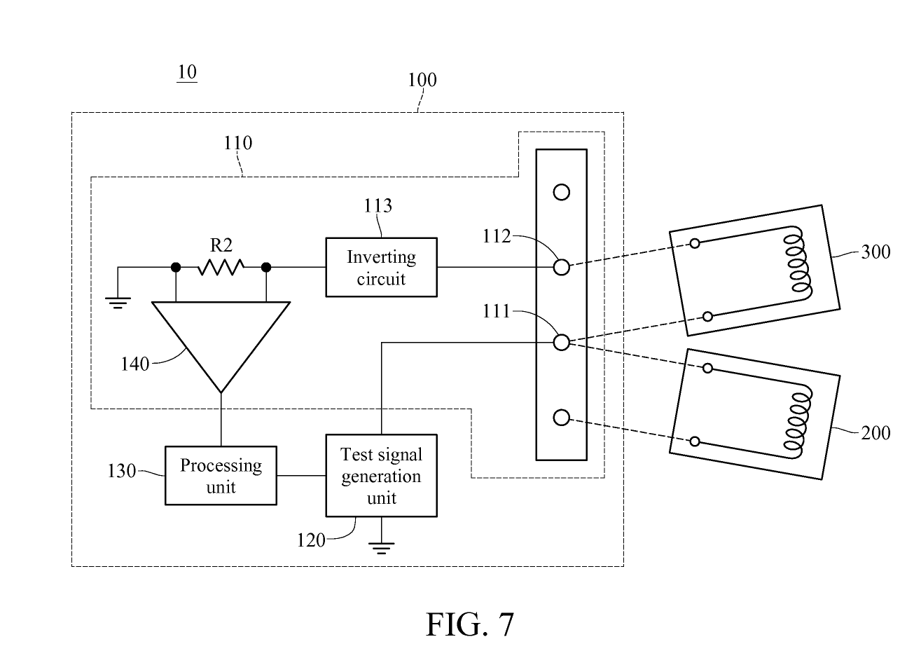

FIG. 7 is a schematic diagram of a fifth embodiment of a network camera with an iris detection function. In this embodiment, the network camera 10 may include not only the elements shown in FIG. 2 but also an inverting circuit 113. The connection manner of the inverting circuit 113 may be like the structure shown in FIG. 7. The operation of the inverting circuit 113 can be referred to the relative description to FIG. 6.

On the other hand, the operation of the network camera 10 in this embodiment can be referred to the relative description to FIG. 2, and may achieve the same effect as the second embodiment.

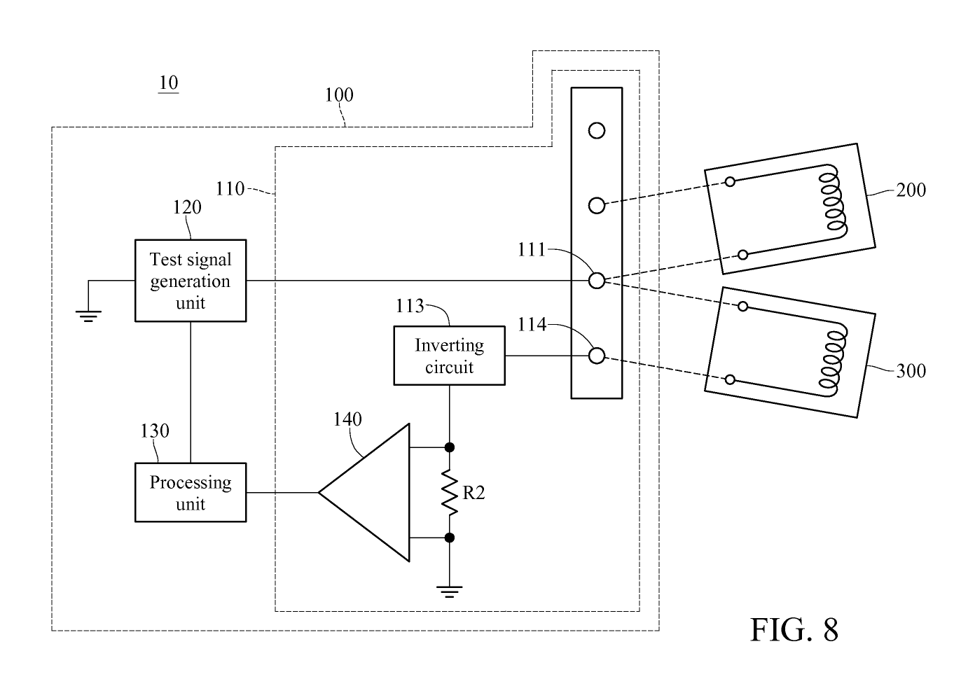

FIG. 8 is a schematic diagram of a sixth embodiment of a network camera with an iris detection function. In this embodiment, the network camera 10 may include not only the elements shown in FIG. 3 but also an inverting circuit 113. The connection manner of the inverting circuit 113 may be like the structure shown in FIG. 8. The operation of the inverting circuit 113 can be referred to the relative description to FIG. 6.

On the other hand, the operation of the network camera 10 in this embodiment can be referred to the relative description to FIG. 3, and may achieve the same effect as the third embodiment.

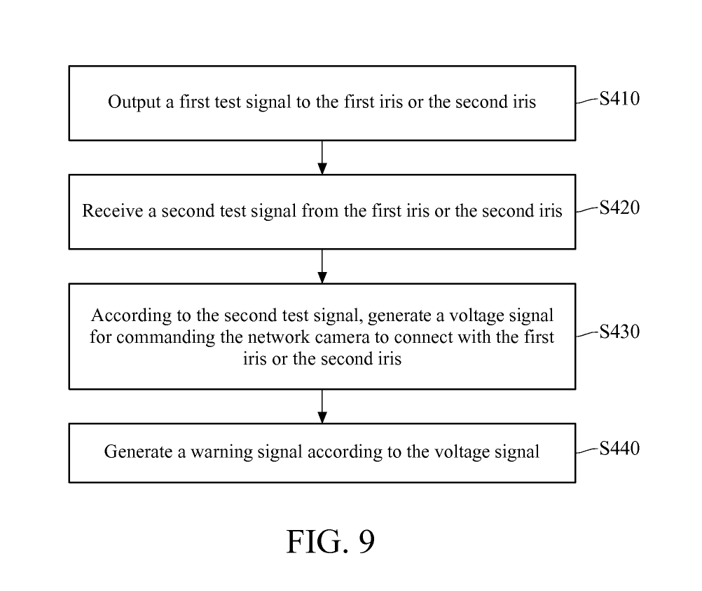

The operation of the above one or more embodiments of the network camera may be summarized in an iris detection method. FIG. 9 is a flow chart of an embodiment of an iris detection method. The iris detection method may detect the connection between the network camera 10 and the first iris 200 or between the network camera 10 and the second iris 300, as shown in FIG. 1.

First, as shown in step S410, output a first test signal to a first iris or a second iris. As shown in step S420, receive a second test signal from the first iris or the second iris.

As shown in step S430, according to the second test signal, generate a voltage signal that commands the network camera to connect to the first iris or the second iris. Furthermore, whether the voltage signal is a high logical level voltage signal or a low logical level voltage signal may be determined.

As shown in step S440, generate a warning signal according to the voltage signal. Specifically, the warning signal may be outputted according to the high logical level voltage signal or the low logical level voltage signal selectively.

In view of the above one or more embodiments, the network camera and the iris detection method in the disclosure may generate a first test signal by the test signal generation unit and output the first test signal to the first iris or the second iris through the test signal output terminal of the detection unit. Then, the test signal receiving terminal may receive a second test signal from the first iris or the second iris responding to the first test signal. Finally, the processing unit may generate a warning signal according to the second test signal. In this way, the categories of irises for the lens set of the network camera may be detected efficiently, and the irises may be protected from being damaged.

What is claimed is:

1. A network camera with an iris detection function, comprising:
a machine body, connected to a first iris or a second iris and comprising:
a detection unit, comprising a test signal output terminal and a test signal receiving terminal;
a test signal generation unit, electrically connected to the detection unit and configured to generate a first test signal and output the first test signal to the first iris or the second iris via the test signal output terminal, wherein the test signal receiving terminal receives a second test signal from the first iris or the second iris; and
a processing unit, electrically connecting to the test signal generation unit and the detection unit and configured to generate a warning signal according to the first test signal and the second test signal.

2. The network camera according to claim 1, wherein when the machine body connects to the first iris, connection between the test signal output terminal and the test signal receiving terminal is disabled; when the test signal generation unit generates and outputs the first test signal, the test signal receiving terminal does not receive the second test signal and the detection unit generates a low logical level voltage signal; when the machine body connects to the second iris, the connection between the test signal output terminal and the test signal receiving terminal is enabled; and when the test signal generation unit generates and outputs the first test signal, the test signal receiving terminal receives the second test signal and the detection unit generates a high logical level voltage signal.

3. The network camera according to claim 2, wherein when the detection unit generates the high logical level voltage signal or the low logical level voltage signal, the processing unit selectively outputs the warning signal.

4. The network camera according to claim 2, wherein the detection unit further comprises:
an inverting circuit, configured to transform the low logical level voltage signal into the high logical level voltage signal when the connection between the test signal output terminal and the test signal receiving terminal is disabled, and to transform the high logical level voltage signal into the low logical level voltage signal when the connection between the test signal output terminal and the test signal receiving terminal is enabled.

5. The network camera according to claim 2, wherein the detection unit further comprising:
a first resistor, one of two ends of the first resistor coupled to the test signal receiving terminal, the other one of the two ends of the first resistor being grounded, the first resistor connecting to the processing unit in parallel, wherein the high logical level voltage signal or the low logical level voltage signal is a voltage difference between the two ends of the first resistor, and the processing unit generates the warning signal according to the voltage difference.

6. The network camera according to claim 2, wherein the detection unit further comprises:
a test signal amplifier, coupled with the test signal receiving terminal and the processing unit and configured to receive and amplify the high logical level voltage signal or the low logical level voltage signal and output the amplified high logical level voltage signal or the amplified low logical level voltage signal to the processing unit.

7. The network camera according to claim 6, wherein the detection unit further comprises:
a second resistor, one of two ends of the second resistor coupled with a first input end of the test signal amplifier and the test signal receiving terminal, the other one of the two ends of the second resistor coupled with a second input end of the test signal amplifier, wherein the high logical level voltage signal or the low logical level voltage signal is a voltage difference between the two ends of the second resistor.

8. The network camera according to claim 1, wherein the first iris and the second iris comprise a precise iris or a DC iris.

9. The network camera according to claim 1, wherein the first test signal comprises a test voltage or a test current.

10. An iris detection method for detecting connection between a network camera and a first iris or connection between the network camera and a second iris, comprising:
outputting a first test signal to the first iris or the second iris;
receiving a second test signal from the first iris or the second iris;
generating a voltage signal according to the second test signal, wherein the voltage signal commands the network camera to connect with the first iris or the second iris; and
generating a warning signal according to the voltage signal.

11. The iris detection method according to claim 10, further comprising:
determining whether the voltage signal is a high logical level voltage signal or a low logical level voltage signal.

12. The iris detection method according to claim 11, further comprising:
selectively sending out the warning signal according to the high logical level voltage signal or the low logical level voltage signal.
